(19) United States
(12) Patent Application Publication
(10) Pub. No.: US 2022/0303838 A1
(43) Pub. Date: Sep. 22, 2022

(54) METHOD, DEVICE AND COMPUTER STORAGE MEDIUM OF COMMUNICATION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 17/636,610

(22) PCT Filed: Sep. 27, 2019
(86) PCT No.: PCT/CN2019/108676

§ 371 Date: Feb. 18, 2022

(51) Int. Cl. H04W 36/00; H04W 36/30

(52) U.S. Cl. CPC H04W 36/0069; H04W 36/305

(57) ABSTRACT

Embodiments of the present disclosure relate to methods, devices and computer readable media for communication. A method of communication comprises transmitting, by a first network device and to each of at least one second network device, a handover request comprising a first indication regarding a type of a handover to the second network device, the type indicating at least one of a condition-based handover and a simultaneous connectivity-based handover; receiving, from each of the at least one second network device, an acknowledgement of the handover request, the acknowledgement comprising a second indication regarding the type of the handover; and transmitting, to a terminal device, a handover command comprising the second indication, for execution of the handover to a first device of the at least one second network device. In this way, both a reduction of handover interruption and an improvement of handover robustness can be achieved.

### TECHNICAL FIELD

Embodiments of the present disclosure generally relate to the field of telecommunication, and in particular, to methods, devices and computer storage media of communication during condition-based handover with simultaneous connectivity.

### BACKGROUND

Third generation partnership project (3GPP) Release-16 is being work on solutions to improve mobility performance including handover interruption reduction and handover robustness improvement. Currently, simultaneous connectivity-based handover (also referred to as enhanced mobile broadband (eMBB) or dual active protocol stack (DAPS)) is proposed. With this solution, handover interruption can be significantly reduced, but handover robustness is poor. As another solution, condition-based handover (also referred to as conditional handover, CHO) is proposed. With this solution, handover robustness is improved, but interruption in this handover is unsatisfactory. In this event, an improved solution of handover is needed to be studied.

### SUMMARY

In general, embodiments of the present disclosure provide methods, devices and computer storage media for communication.

In a first aspect, there is provided a method of communication. The method comprises: transmitting, by a first network device and to each of at least one second network device, a handover request comprising a first indication regarding a type of a handover to the second network device, the type indicating at least one of a condition-based handover and a simultaneous connectivity-based handover; receiving, from each of the at least one second network device, an acknowledgement of the handover request, the acknowledgement comprising a second indication regarding the type of the handover; and transmitting, to a terminal device, a handover command comprising the second indication, for execution of the handover to a first device of the at least one second network device.

In a second aspect, there is provided a method of communication. The method comprises: receiving, at a terminal device and from a first network device, a handover command comprising a second indication regarding a type of a handover to each of at least one second network device, the type indicating at least one of a condition-based handover and a simultaneous connectivity-based handover; and executing the handover to a first device of the at least one second network device based on the second indication.

In a third aspect, there is provided a method of communication. The method comprises: receiving, by a second network device and from a first network device, a handover request comprising a first indication regarding a type of a handover to the second network device, the type indicating at least one of a condition-based handover and a simultaneous connectivity-based handover; generating a second indication regarding the type of the handover based on the first indication; and transmitting, to the first network device, the second indication in an acknowledgement of the handover request, for transmission of a handover command comprising the second indication to a terminal device for execution of the handover.

In a fourth aspect, there is provided a first network device. The first network device comprises a processor and a memory coupled to the processor. The memory stores instructions that when executed by the processor, cause the network device to perform the method according to the first aspect of the present disclosure.

In a fifth aspect, there is provided a terminal device. The terminal device comprises a processor and a memory coupled to the processor. The memory stores instructions that when executed by the processor, cause the transmitting device to perform the method according to the second aspect of the present disclosure.

In a sixth aspect, there is provided a second network device. The second network device comprises a processor and a memory coupled to the processor. The memory stores instructions that when executed by the processor, cause the transmitting device to perform the method according to the third aspect of the present disclosure.

In a seventh aspect, there is provided a computer readable medium having instructions stored thereon. The instructions, when executed on at least one processor, cause the at least one processor to perform the method according to the first aspect of the present disclosure.

In an eighth aspect, there is provided a computer readable medium having instructions stored thereon. The instructions, when executed on at least one processor, cause the at least one processor to perform the method according to the second aspect of the present disclosure.

In a ninth aspect, there is provided a computer readable medium having instructions stored thereon. The instructions, when executed on at least one processor, cause the at least one processor to perform the method according to the third aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating a process for communication during a condition-based handover with simultaneous connectivity according to embodiments of the present disclosure;

FIG. 3 is a schematic diagram illustrating some example formats of medium access control (MAC) control element (CE) for carrying a fourth indication in accordance with embodiments of the present disclosure;

FIG. 4 illustrates an example method of communication implemented at a first network device as a source network device in accordance with some embodiments of the present disclosure;

FIG. 5 illustrates an example method of communication implemented at a terminal device in accordance with some embodiments of the present disclosure;

FIGS. 6A and 6B illustrate an example method of handover execution implemented at the terminal device in accordance with some embodiments of the present disclosure;

FIG. 7 illustrates an example method of failure handling implemented at the terminal device in accordance with some embodiments of the present disclosure;

FIG. 8 illustrates another example method of failure handling implemented at the terminal device in accordance with some embodiments of the present disclosure;

FIG. 9 illustrates an example method of communication implemented at a second network device as a target network device in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As mentioned above, simultaneous connectivity-based handover is studied for handover interruption reduction, and CHO is studied for handover robustness improvement. In the meanwhile, how to combine the condition-based handover and the simultaneous connectivity-based handover for use becomes a hot issue.

Embodiments of the present disclosure provide a solution for communication during the CHO with simultaneous connectivity. The solution can achieve both a reduction of handover interruption and an improvement of handover robustness. Principles and implementations of the present disclosure will be described in detail below with reference to the figures.

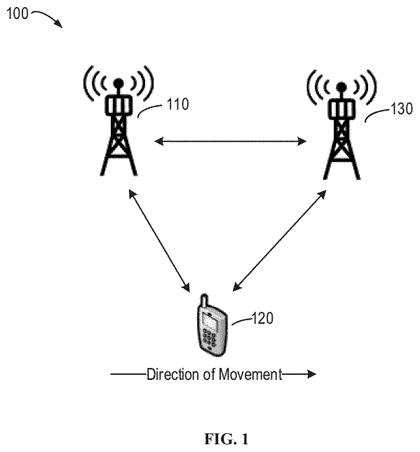

FIG. 1 illustrates a schematic diagram of an example communication network 100 in which embodiments of the present disclosure can be implemented. As shown in FIG. 1, the communication network 100 may include a first network device 110 and a terminal device 120 served by the first network device 110. The communication network 100 may further include at least one second network device 130 (only one is shown in FIG. 1 for concise), and the terminal device 120 may be handed over from the first network device 110 to one of the at least one second network device 130 (for convenience, the one device may also be called a first device 130 hereafter) that satisfies a condition of execution of a handover. It is to be understood that the number of devices in FIG. 1 is given for the purpose of illustration without suggesting any limitations to the present disclosure. The communication network 100 may include any suitable number of network devices and/or terminal devices adapted for implementing implementations of the present disclosure.

As shown in FIG. 1, the first network device 110 may communicate with the terminal device 120 via a channel such as a wireless communication channel. Similarly, the at least one second network device 130 may also communicate with the terminal device 120 via a channel such as a wireless communication channel. The first and second network devices 110 and 130 may communicate with each other.

For example, in an earlier stage, the terminal device 120 is served by the first network device 110 and a first connection is maintained between the terminal device 120 and the first network device 110. During the terminal device 120 is moving toward the at least one second network device 130 in a direction of movement as shown in FIG. 1, a CHO with simultaneous connectivity may be triggered. When the CHO with simultaneous connectivity is triggered, the terminal device 120 may establish a second connection with the first device of the at least one second network device 130 while maintaining the first connection with the first network device 110.

During a simultaneous connectivity based handover, the terminal device 120 may keep the first and second connections with the first and second network devices 110 and 130 simultaneously. In this time, two active protocol stacks are maintained between the terminal device 120 and the first and second network devices 110 and 130.

In the following, some embodiments will be described with reference to the first network device 110 as an example of a source network device and with reference to the at least one second network device 130 as an example of candidate target network device(s). For example, the first network device 110 may also be referred to as the “source network device 110”, and the at least one second network device 130 may also be referred to as the “candidate target network device 130”. It is to be understood that this is merely for the purpose of discussion, without suggesting any limitations to the scope of the present disclosure.

The communications in the communication network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

For executing a CHO, a condition of handover and a condition of execution of handover are preset. The condition of handover is used during measurement to determine one or more candidate target network devices 130 that are slightly better than the first network device 110 in serving the terminal device 120. For example, these candidate target network devices 130 may provide a signal strength larger than that provided by the first network device 110 by 1 dB. The terminal device 120 may report these candidate target network devices 130 to the first network device 110. Then the first network device 110 may transmit handover configurations of these candidate target network devices 130 when the channel between the first network device 110 and the terminal device 120 is still under good condition.

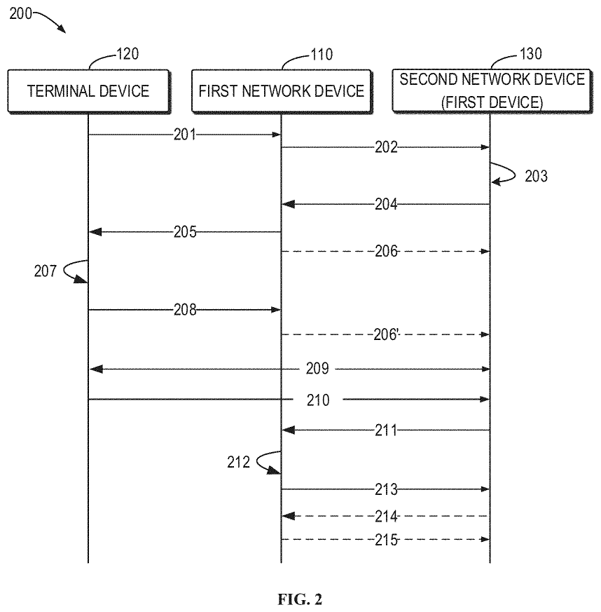

The condition of execution of handover is used to determine which one of these candidate target network devices 130 would be handed over to. The condition of execution of handover may be determined by candidate target network devices 130 separately. In other words, when the first device 130 satisfies its condition of execution of handover, the terminal device 120 may perform autonomous connection with the first device 130, without the first network device 110 sending explicit radio resource control (RRC) message to instruct the start of execution of handover. For example, if a signal strength larger than that provided by the first network device 110 by 3 dB is attained, the handover can be executed. It should be note that, the above example 1 dB or 3 dB is merely for illustration and not for limitation. The condition of handover and condition of execution of handover can be set in any suitable way, and the present application does not make any limitation for this. The present application is to achieve simultaneous connectivity during the CHO, and this will be described below with reference to FIG. 2.

FIG. 2 shows a schematic diagram illustrating a process 200 for communication during a CHO with simultaneous connectivity according to embodiments of the present disclosure. For the purpose of discussion, the process 200 will be described with reference to FIG. 1. The process 200 may involve the terminal device 120 and the first and second network devices 110 and 130 as illustrated in FIG. 1. For concise, actions are described with reference to only one second network device 130.

As shown in FIG. 2, the terminal device 120 may transmit 201 a measurement report to the first network device 110, the measurement report showing that each of the at least one second network device 130 is more suitable for serving the terminal device 120. In this point, the measurement report is determined based on the condition of handover and can be implemented in any suitable way, and the present application does not make limitation for this.

Upon receiving the measurement report, the first network device 120 may transmit 202 a handover request to each of the at least one second network device 130. The handover request may include a first indication regarding a type of a handover to be executed with respect to each of the at least one second network device 130. In some embodiments, the type may indicate a combination of CHO and a simultaneous connectivity-based handover (for convenience, it will be briefly referred to as DAPS hereafter). In some alternative embodiments, the type may only indicate a CHO. In some alternative embodiments, the type may only indicate a DAPS.

In some embodiments in which the type indicates a combination of CHO and

DAPS, the first network device 110 may indicate whether it is applied to all data radio bearers (DRBs). In some embodiments in which it is applied to a part of DRBs, the first network device 110 may indicate an explicit DRB identification (ID).

In response to receiving the handover request, each of the at least one second network device 130 may generate 203 a second indication regarding the type of the handover. In this regard, each of the at least one second network device 130 can modify the type of the handover to itself. For example, assuming that the first indication shows a combination of CHO and DAPS, the second network device 130 can modify the handover as only CHO or only DAPS as needed.

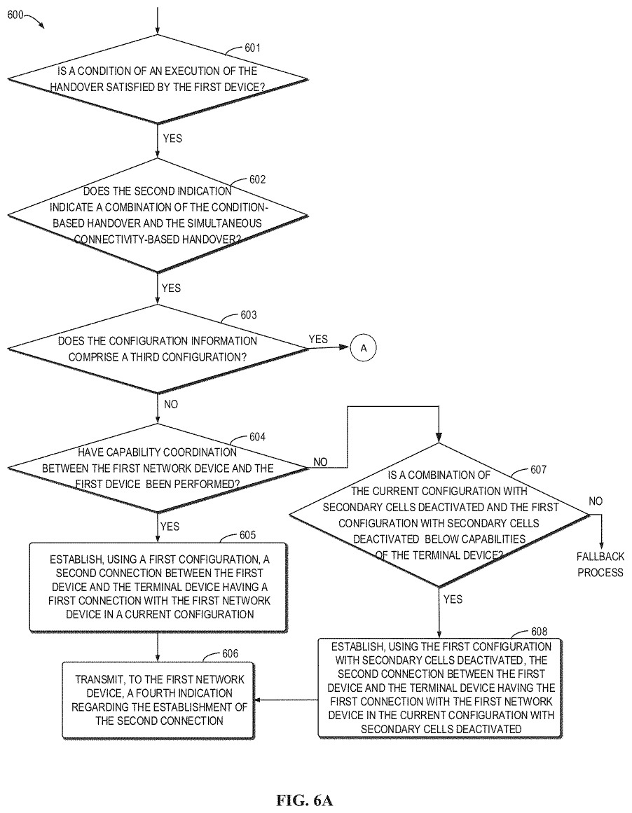

The at least one second network device 130 may transmits 204 the second indication in an acknowledgement of the handover request. In this regard, the at least one second network device 130 feedbacks the final handover type. In some embodiments, in which the type indicates a combination of CHO and DAPS, the second network device 130 may feedback, in the acknowledgement, a first configuration of this second network device 130 that is to be used for the combination. Additionally or optically, the second network device 130 may also feedback, in the acknowledgement, a second configuration of this second network device 130 to be used in a fallback process. The fallback process will be described in connection with FIGS. 6A and 6B later.

In some embodiments in which capability coordination between the first network device 110 and this second network device is not performed for a DAPS or a combination of a CHO and DAPS, this second network device 130 may generate the first configuration with secondary cells deactivated/released explicitly.

Upon receiving the acknowledgement from each of the at least one second network device 130, the first network device 110 may transmit 205, to the terminal device 120, a handover command comprising all the second indications associated with the at least one second network device 130.

In some additional embodiments, the first network device 110 may transmit configuration information associated with the handover to the terminal device 120. The configuration information is provided for each of the at least one second network device 130 and comprises at least one of the following: an ID of the second network device 130; a condition of an execution of the handover; a third indication regarding whether capability coordination between the first network device 110 and the second network device 130 has been performed; the first configuration; the second configuration; and a third configuration regarding the first network device 110 that is to be used during the handover.

In some embodiments in which the at least one second network device 130 comprises a single second network device, i.e., the first device 130, the first network device 110 may transmit 206, upon transmitting the handover command, downlink data that is to be transmitted to the terminal device 120 and sequence number information associated with the first data packet associated with the downlink data. In other words, once transmitting the handover command, the first network device 110 may start to forward downlink (DL) data of the terminal device 120 to the first device 130. In this way, data integrity can be ensured, and data transmission latency can be reduced once the handover to the first device 130 is successfully executed. Even if the handover to the first device 130 is failed, the cost of data forwarding is ignorable.

For example, in the data forwarding for both radio link control (RLC) acknowledged mode (AM) and RLC unacknowledged mode (UM) bearer, the COUNT value of the first DL data packet (e.g., packet data convergence protocol (PDCP) service data units (SDUs)) forwarded from the first network device 110 to the first device 130 may be carried by a SN STATUS TRANSFER message, and the sequence number (SN) of the forwarded DL data packets is carried in the “PDCP PDU number” field of a GPRS tunneling protocol for user plane (GTP-U) extension header.

In response to receiving the handover command, the terminal device 120 may evaluates 207 all the conditions of execution of handover associated with each of the at least one second network device 130. If one of the at least one second network device 130 (i.e., the first device 130) satisfies its condition, the terminal device 130 may start to establish a second connection with the first device 130.

At this moment, if the second indication shows that a CHO or a combination of a CHO and DAPS shall be applied, in some embodiments, the terminal device 120 may transmit 208, to the first network device 110, a fourth indication (e.g., “bye” message) regarding establishment of the second connection between the first device 130 and the terminal device 120 having a first connection with the first network device 110. Upon receiving the fourth indication, the first network device 110 may transmit 206′ downlink data of the terminal device 120 and sequence number information associated with the first data packet of the downlink data to the first device 130, i.e., perform data forwarding to the first device 130. In this way, data integrity also can be ensured.

The fourth indication can be transmitted in any suitable manner existing now or to be developed in future. Regarding its content, in some embodiments in which the at least one second network device 130 comprises a plurality of second network devices, the fourth indication may comprise an indication (also referred to as first information herein) of ID of the target device, i.e., first device 130. In some alternative embodiments in which the at least one second network device 130 comprises a single second network device (i.e., first device 130), the fourth indication may comprise an indication (also referred to as second information herein) of an execution of the handover.

Regarding the transmission of the fourth indication, in some embodiments, the fourth indication may be transmitted in a higher layer signaling message. For example, the fourth indication may be transmitted by a RRC message, e.g., by using UEAssistanceInfomation message. It can be transmitted before execution of the handover, i.e., signaling radio bearer (SRB) reestablishment.

In some alternative or additional embodiments, the fourth indication may be transmitted in a MAC CE. In some embodiments in which there is uplink grant, the MAC CE may be sent directly. In some embodiments in which there is no uplink grant, the terminal device 120 may transmit a special scheduling request (SR) to the first network device 110 and transmit the MAC CE to the first network device 110 in a grant from the first network device 110 in response to the special SR.

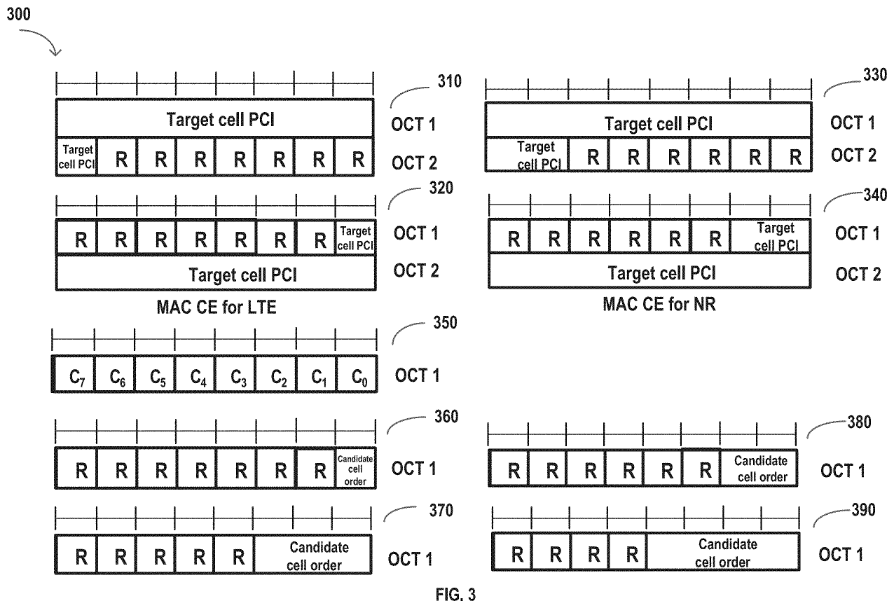

FIG. 3 is a schematic diagram 300 illustrating illustrates some example formats of medium access control (MAC) control element (CE) for carrying a fourth indication in accordance with embodiments of the present disclosure. In embodiments shown in FIG. 3, the at least one second network device 130 comprises a plurality of second network devices.

As shown in FIG. 3, formats 310-340 show an embodiment in which a physical cell identification (PCI) of the first device 130 (e.g., as shown by Target cell PCI in FIG. 3) is placed in a predetermined field of MAC CE. For example, formats 310 and 320 show examples of MAC CEs for LTE, and formats 330 and 340 show examples of MAC CEs for NR.

Format 350 shows an embodiment in which the plurality of second network devices are associated with fields of MAC CE in an order of their PCIs, and one bit associated with each field is used to indicate whether the second network device associated with the field is the first device 130. For example, as shown in format 350 of FIG. 3, Ci (i=0 . . . 7) indicates whether candidate cell i is the target cell, where i is the ascending order of the PCI among the candidate cells configured to the UE. Ci=1 indicates the corresponding candidate cell is selected, and Ci=0 indicates the corresponding candidate cell is not selected.

Formats 360-390 show an embodiment in which an indication (e.g., as shown by Candidate cell order in FIG. 3) regarding an order of a PCI of the first device 130 among the plurality of second network devices is placed in a predetermined field of MAC CE.

In some embodiments in which the at least one second network device 130 comprises a single second network device (i.e., the first device 130), the fourth indication may be transmitted by a MAC CE having a header (e.g., MAC subheader) with a logic channel identification (LCID) and a size of zero bits. For example, in some embodiments for LTE, the LCID for the MAC CE can be 01111 or 01110. In some embodiments for NR, the LCID for the MAC CE can be 51 or 50.

So far, the transmission of the fourth indication in MAC CE is described. As an alternative or in addition, the terminal device 120 may transmit the fourth indication on a dedicated uplink resource (in other words, dedicated SR configuration). In some embodiments, the dedicated SR configuration may be configured by RRC. In some embodiments in which the at least one second network device 130 comprises a plurality of second network devices, each second network device may be mapped to one SR configuration. If one of the second network devices is selected as the first device 130, the first network device 110 may transmit the fourth indication using the SR configuration corresponding to this second network device.

Return back to FIG. 2, upon transmitting the fourth indication, the terminal device 120 may perform 209 a random access channel (RACH) procedure with the second network device 130 (i.e., the first device 130) so as to establish a connection (i.e., the second connection) with the first device 130. So far, simultaneous connections between terminal device 120 and the first and second network devices 110 and 130 are established.

Upon the completion of the RACH procedure, the terminal device 120 may transmit 210, to the first device 130, a handover complete message such as RRCConnectionReconfigurationCompleteIRRCReconfigurationComplete message. Then the first device 130 may transmit 211 third information indicating completion of the handover to the first network device 110, for example, via X2/Xn interface or S1/NG interface. Upon receiving the third information, the first network device 110 decides 212 whether to stop scheduling uplink data to the terminal device 120. If the first network device 110 decides 212 to stop scheduling uplink data to the terminal device 120, the first network device 110 may transmit 213, to the first device 130, uplink (UL) data that has been received by the first network device 110 from the terminal device 120 and sequence number information associated with the first data packet of the uplink data.

For example, in data forwarding for RLC AM, the first network device 110 may transmit, to a further network device (for example, serving gateway (SGW)/user plane function (UPF)), UL data packets (e.g., PDCP SDUs) that are received in-sequence, and forward, to the first device 130, UL data packets that are not ordered and form the first missing packet. Meanwhile, the first network device 110 may also inform the first device 130 of the receiving status of UL data packets and UL COUNT Value by a SN STATUS TRANSFER message. In data forwarding for RLC UM, the first network device 110 may transmit, to the SGW/UPF, all the UL data packets that are received by the first network device 110.

Then the first network device 110 may be released. The release may be triggered by the terminal device 110, the first device 130, or the first network device 110 itself in any suitable way. In some embodiments, the first device 130 may transmit 214 fourth information indicating at least one of a release of the first network device 110, a switch of sequence number allocation, and path switch from the first network device 110 to the first device 130. Upon receiving the third and fourth information, the first network device 110 may transmit 215, to the first device 130, downlink data that is to be transmitted to the terminal device 120 and sequence number information associated with the first data packet of the downlink data.

For example, in data forwarding for RLC AM bearer, the first network device 110 may forward, to the first device 130, DL data packets (e.g., PDCP SDUs) that are transmitted by the first network device 110 but have their SNs that have not been acknowledged by the terminal device 120, DL data packets that have not been transmitted by the first network device 110 or have not been transmitted to the first device 130, and new DL data packets that have been received from the SGW/UPF. Meanwhile, the first network device 110 may also inform the DL COUNT Value to the first device 130 by a SN STATUS TRANSFER message.

For example, in data forwarding for RLC UM bearer, the first network device 110 may forward, to the first device 130, DL data packets that have not been transmitted by the first network device 110 or have not been transmitted to the first device 130, and new DL data packets that have been received from the SGW/UPF. Meanwhile, the first network device 110 may also inform the DL COUNT Value to the first device 130 by a SN STATUS TRANSFER message.

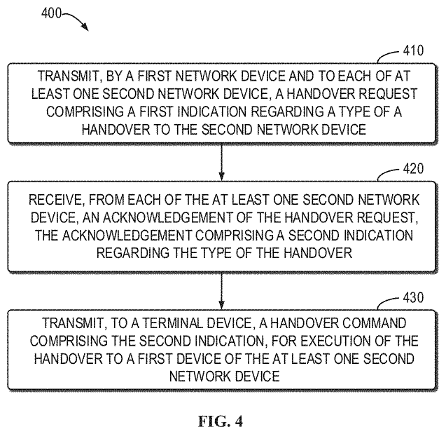

It should be note that actions shown in FIG. 2 are not always necessary for implementing embodiments of the present disclosure, and more or less actions may be adapted as needed. Corresponding to the process described in FIG. 2, embodiments of the present disclosure provide methods of communication implemented at source and (candidate) target network devices and at a terminal device. These methods will be described below with reference to FIGS. 4 to 9.

FIG. 4 illustrates an example method 400 of communication implemented at a first network device as a source network device in accordance with some embodiments of the present disclosure. For example, the method 400 may be performed at the first network device 110 as shown in FIG. 1. For the purpose of discussion, in the following, the method 400 will be described with reference to FIG. 1. It is to be understood that the method 400 may include additional blocks not shown and/or may omit some blocks as shown, and the scope of the present disclosure is not limited in this regard.

At block 410, the first network device 110 may transmit, to each of the at least one second network device 130, a handover request comprising a first indication regarding a type of a handover to this second network device. The type indicates at least one of a CHO and DAPS.

At block 420, the first network device 110 may receive, from each of the at least one second network device 130, an acknowledgement of the handover request. The acknowledgement comprises a second indication regarding the type of the handover. In some embodiments, the second indication may different from the first indication. In some embodiments, the second indication may be the same as the second indication.

In some embodiments in which the second indication indicates a combination of the CHO and DAPS, the acknowledgement may further comprises a first configuration of this second network device that is to be used for the combination. In some additional embodiments, the acknowledgement may further comprise a second configuration of this second network device that is to be used in a fallback process.

At block 430, the first network device 110 may transmit, to the terminal device 120, a handover command comprising the second indication, for execution of the handover to a first device of the at least one second network device 130.

In some embodiments, the first network device 110 may further transmit configuration information associated with the handover to the terminal device 120. The configuration information is provided for each of the at least one second network device 130 and comprises at least one of the following: an ID of this second network device; a condition of an execution of the handover; a third indication regarding whether capability coordination between the first network device and this second network device has been performed; the first configuration; the second configuration; and a third configuration regarding the first network device 110 that is to be used during the handover.

In some embodiments in which capability coordination between the first network device and this second network device is not performed for a DAPS or a combination of the CHO and DAPS, the first network device 110 may generate the third configuration with secondary cells deactivated/released explicitly.

In some embodiments in which the at least one second network device 130 comprises a single second network device, upon transmitting the handover command, the first network device 110 may further transmit, to the single second network device, downlink data that is to be transmitted to the terminal device 120 and sequence number information associated with the first data packet of the downlink data.

In some embodiments in which a second connection between the first device 130 and the terminal device 120 is established, the first network device 110 may further receive a fourth indication regarding establishment of a second connection between the first device 130 and the terminal device 120 having a first connection with the first network device 110. Upon receiving the fourth indication, the first network device 110 may transmit, to the first device 130, downlink data that is to be transmitted to the terminal device 120 and sequence number information associated with the first data packet of the downlink data.

In some embodiments in which the at least one second network device 130 comprises a plurality of second network devices, the first network device 110 may receive, as the fourth indication, first information indicating an identification of the first device 130. In some embodiments in which the at least one second network device 130 comprises a single second network device, the first network device 110 may receive, as the fourth indication, second information indicating an execution of the handover. In some embodiments, the first network device 110 may receive the fourth indication in at least one of a higher layer signaling message, a MAC CE, and a dedicated uplink resource.

In some embodiments in which the at least one second network device 130 comprises a plurality of second network devices associated with different dedicated uplink resources, the first network device 110 may receive the fourth indication in a corresponding dedicated uplink resource associated with the first device 130.

In some embodiments in which the at least one second network device 130 comprises a plurality of second network devices, the first network device 110 may receive a PCI of the first device 130 in a predetermined field of a MAC CE.

In some embodiments in which the at least one second network device 130 comprises a plurality of second network devices and the plurality of second network devices are associated with fields of a MAC CE in an order of PCI of the plurality of second network devices, the first network device 110 may receive, in each of the fields, a bit indicating whether a second network device associated with the field is the first device 130.

In some embodiments in which the at least one second network device 130 comprises a plurality of second network devices, the first network device 110 may receive, in a predetermined field of a MAC CE, an indication regarding an order of a PCI of the first device among the plurality of second network devices.

In some embodiments in which the at least one second network device 130 comprises a single second network device, the first network device 110 may receive a MAC

CE that has a header with a LCID and a size of zero bits.

In some embodiments, the first network device 110 may further receive, from the first device 130, third information indicating completion of a handover to the first device 130. Upon receiving the third information and deciding to stop scheduling uplink data to the terminal device 120, the first network device 110 may transmit, to the first device 130, uplink data that has been received by the first network device 110 from the terminal device 120 and sequence number information associated with the first data packet of the uplink data.

In some alternative or additional embodiments, upon receiving the third information and also receiving, from the first device 130, fourth information indicating at least one of a release of the first network device 110, a switch of sequence number allocation, and path switch from the first network device 110 to the first device 130, the first network device 110 may transmit, to the first device 130, downlink data that is to be transmitted to the terminal device and sequence number information associated with the first data packet of the downlink data.

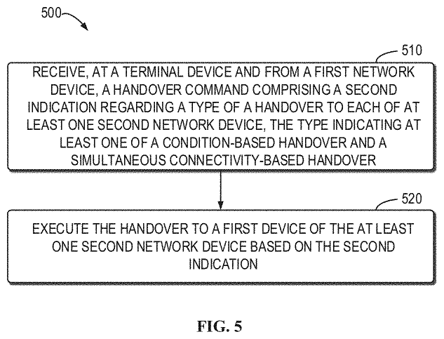

FIG. 5 illustrates an example method 500 of communication implemented at the terminal device in accordance with some embodiments of the present disclosure. For example, the method 500 may be performed at the terminal device 120 as shown in FIG. 1. For the purpose of discussion, in the following, the method 500 will be described with reference to FIG. 1. It is to be understood that the method 500 may include additional blocks not shown and/or may omit some blocks as shown, and the scope of the present disclosure is not limited in this regard.

As shown in FIG. 5, at block 510, the terminal device 120 may receive, from the first network device 110, a handover command comprising a second indication regarding a type of a handover to each of at least one second network device 130. The type indicates at least one of a CHO and DAPS.

In some embodiments, the terminal device 120 may further receive, from the first network device 110, configuration information associated with the handover. The configuration information is provided for each of the at least one second network device 130 and comprises at least one of the following: an ID of this second network device; a condition of an execution of the handover; a third indication regarding whether capability coordination between the first network device 110 and this second network device has been performed; the first configuration; the second configuration; and a third configuration regarding the first network device 110 that is to be used during the handover.

At block 520, the terminal device 120 may execute the handover to a first device of the at least one second network device 130 based on the second indication. Regarding the execution of the handover to the first device 130, it will be described below with reference to FIGS. 6A and 6B. FIGS. 6A and 6B illustrate an example method 600 of handover execution implemented at the terminal device in accordance with some embodiments of the present disclosure. For example, the method 600 may be performed at the terminal device 120 as shown in FIG. 1. For the purpose of discussion, in the following, the method 600 will be described with reference to FIG. 1. It is to be understood that the method 600 may include additional blocks not shown and/or may omit some blocks as shown, and the scope of the present disclosure is not limited in this regard.

Upon receiving the handover command from the first network device 110, the terminal device 120 may evaluate the conditions of execution of handover. As shown in FIG. 6A, at block 601, the terminal device 120 may determine whether the condition of execution of handover is satisfied by the first device 130. If determining that the condition of execution of handover is satisfied by the first device 130, at block 602, the terminal device 130 may determine whether the second indication associated with the first device 130 indicates a combination of a CHO and DAPS.

If determining that the second indication indicates the combination of a CHO and DAPS, at block 603, the terminal device 130 may determine whether the configuration information associated with the first device 130 comprises a third configuration regarding the first network device 110 that is to be used during the handover.

If determining that the configuration information does not comprise the third configuration, at block 604, the terminal device 120 may determine whether capability coordination between the first network device 110 and the first device 130 has been performed, for example, via the third indication comprised in the configuration information.

If determining that the capability coordination has been performed, at block 605, the terminal device 120 may establish, using a first configuration regarding the first device 130 that is to be used for the combination, a second connection between the first device 130 and the terminal device 120, while keeping a first connection with the first network device 110 in a current configuration.

Upon the second connection between the first device and the terminal device having the first connection with the first network device being established, at block 606, the terminal device 120 may transmit, to the first network device 110, a fourth indication regarding the establishment of the second connection.

In some embodiments in which the at least one second network device 130 comprises a plurality of second network devices, the terminal device 120 may transmit, as the fourth indication, first information indicating an identification of the first device 130. In some embodiments in which the at least one second network device 130 comprises a single second network device, the terminal device 120 may transmit, as the fourth indication, second information indicating an execution of the handover. In some embodiments, the terminal device 120 may transmit the fourth indication in at least one of a higher layer signaling message, a MAC CE, and a dedicated uplink resource.

In some embodiments in which the at least one second network device 130 comprises a plurality of second network devices and the plurality of second network devices are associated with different dedicated uplink resources, the terminal device 120 may transmit the fourth indication in a corresponding dedicated uplink resource associated with the first device.

In some embodiments in which the at least one second network device 130 comprises a plurality of second network devices, the terminal device 120 may transmit a PCI of the first device 130 in a predetermined field of a MAC CE.

In some embodiments in which the at least one second network device 130 comprises a plurality of second network devices and the plurality of second network device are associated with fields of a MAC CE in an order of physical cell identifications of the plurality of second network devices, the terminal device 120 may transmit, in each of the fields, a bit indicating whether a second network device associated with the field is the first device 130.

In some embodiments in which the at least one second network device comprises a plurality of second network devices, the terminal device 120 may transmit, in a predetermined field of a MAC CE, an indication regarding an order of a PCI of the first device 130 among the plurality of second network devices.

In some embodiments in which the at least one second network device 130 comprises a single second network device, the terminal device 120 may transmit a MAC CE that has a header with a LCID and a size of zero bits. Other details regarding the transmission of the fourth indication may refer to that described above in connection with

FIG. 2.

Return to block 604, if determining the capability coordination has not been performed, at block 607, the terminal device 120 may determine whether a combination of the current configuration with secondary cells deactivated and the first configuration with secondary cells deactivated is below capabilities of the terminal device 120. If determining that the combination of the current configuration with secondary cells deactivated and the first configuration with secondary cells deactivated is below capabilities of the terminal device 120, at block 608, the terminal device 120 may establish, using the first configuration with secondary cells deactivated, the second connection between the first device and the terminal device, while keeping the first connection with the first network device in the current configuration with secondary cells deactivated.

If determining, at block 607, that the combination of the current configuration with secondary cells deactivated and the first configuration with secondary cells deactivated is above capabilities of the terminal device 120, the terminal device 120 may perform a fallback process.

In some embodiments, the terminal device 120 may release the first connection with the first network device 110 and then establish the second connection between the first device 130 and the terminal device 120. In this way, the handover is fallback to a CHO. For example, the terminal device 120 may release the configuration of the first network device 110, reset MAC, re-establish PDCP and RLC entities, and then start to initiate random access to the first device 130 using the first configuration for DAPS or the second configuration for fallback.

In some alternative embodiments, the terminal device 120 may maintain the first connection with the first network device 110 in the current configuration until initiating a random access to the first device 130 in establishment of the second connection between the first device 130 and the terminal device 120. In this way, the handover is fallback to a combination of a CHO and a mobile broadband (MBB). For example, the terminal device 120 may continue to perform data transmission with the first network device 110 using the current configuration. Immediately before initiating random access to the first device 130, the terminal device 110 may release the first connection with the first network device 110, reset MAC, re-establish PDCP and RLC entities, and applies the first configuration for DAPS or the second configuration for fallback for random access and the following data transmission.

In some alternative embodiments, the terminal device 120 may ignore the execution of the handover as the fallback process. In other words, this is a control plane (CP) handling for the combination of a CHO and DAPS. In some embodiments, the terminal device 120 may stop transmitting any RRC signaling messages to the first network device 110 during the handover execution. In some embodiments, the terminal device 120 may still receive RRC signaling data from the first network device 110, but discard the signaling data. In some embodiments, the terminal device 120 may store the RRC context and stop processing any RRC signaling messages from the first network device 110 during the execution of the handover for the combination of a CHO and DAPS. In some embodiments, this can be realized by reestablishing the SRBs from the first network device 110 to the first device 130.

With reference to FIG. 6B, if determining, at block 603, that the configuration information comprise the third configuration, at block 609, the terminal device 120 may determine whether capability coordination between the first network device 110 and the first device 130 has been performed, for example, via the third indication comprised in the configuration information. The processing at block 609 is similar with that at block 604.

If determining, at block 609, that the capability coordination has been performed, at block 610, the terminal device 120 may establish, using a first configuration regarding the first device 130 that is to be used for the combination, a second connection between the first device 130 and the terminal device 120, while keeping a first connection with the first network device in the third configuration. In other words, the terminal device 120 may apply the third configuration of the first network device 110 to maintain the user plane, and meanwhile start to initiate random access to the first device 130 using the first configuration of the first device 130.

At block 611, the terminal device 120 transmits, to the first network device 110, a fourth indication regarding establishment of the second connection. In this case, upon receiving the fourth indication, the first network device 110 shall apply the third configuration of the first network device 110 and start to perform data forwarding to the first device 130. The processing at block 611 is similar with that at block 606.

If determining, at block 609, that the capability coordination has not been performed, at block 612, the terminal device 120 may determine whether a combination of the third configuration with secondary cells deactivated and the first configuration with secondary cells deactivated is below capabilities of the terminal device 120.

If determining, at block 612, that the combination of the third configuration with secondary cells deactivated and the first configuration with secondary cells deactivated is below capabilities of the terminal device 120, at block 613, the terminal device 120 may transmit, using the current configuration and to the first network device 110, the fourth indication regarding the establishment of the second connection.

At block 614, the terminal device 120 may determine whether the fourth indication is successfully transmitted. In some embodiments, the terminal device 120 may perform the determination by its implementation.

In some alternative or additional embodiments, the terminal device 120 may perform the determination by using a newly-defined timer. For example, if receiving an acknowledgement for the transmission of the fourth indication within a preset time period, the terminal device 120 may determine that the fourth indication is successfully transmitted. Otherwise, the terminal device 120 may determine that the fourth indication is not successfully transmitted.

In some alternative or additional embodiments, the terminal device 120 may perform the determination by limiting the number of transmission times. For example, if the number of the transmission of the fourth indication is above a preset value and an acknowledgement for the transmission of the fourth indication is still not received, the terminal device 120 may determine that the fourth indication is not successfully transmitted. Otherwise, the terminal device 120 may determine that the fourth indication is successfully transmitted.

If determining, at block 614, that the fourth indication is successfully transmitted, at block 615, the terminal device 120 may establish, using the first configuration with secondary cells deactivated, the second connection between the first device 130 and the terminal device 120, while keeping the first connection with the first network device 110 in the third configuration with secondary cells deactivated. If determining, at block 614, that the fourth indication is not successfully transmitted, the terminal device 120 may perform the fallback process as described above. Details of the fallback process are not repeated here.

Return to block 612, if determining that the combination of the third configuration with secondary cells deactivated and the first configuration with secondary cells deactivated is above capabilities of the terminal device 120, the terminal device 120 may also perform the fallback process as described above. Details of the fallback process are not repeated here.

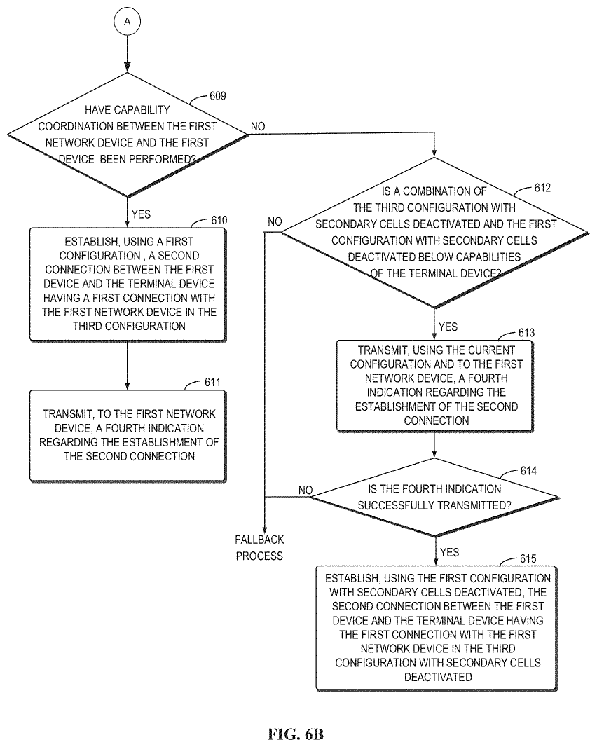

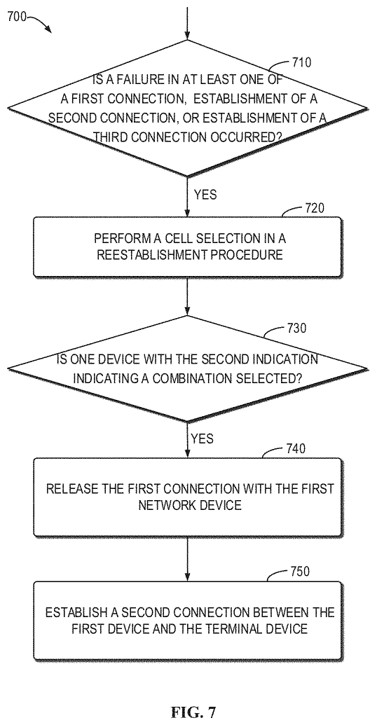

So far, the execution of the handover to the first device 130 is described. Next, handling of a failure in the handover will be described below in connection with FIGS. 7 and 8. FIG. 7 illustrates an example method 700 of failure handling implemented at the terminal device in accordance with some embodiments of the present disclosure. For example, the method 700 may be performed at the terminal device 120 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

As shown in FIG. 7, at block 710, the terminal device 120 may determine whether at least one of the following is occurred: a failure in a first connection between the terminal device 120 and the first network device 110, a failure in establishment of a second connection between the terminal device 120 and the first device 130 during the condition-based handover, or a failure in establishment of a third connection between the terminal device 120 and a third network device during a handover (i.e., legacy handover) other than the CHO and DAPS.

If determining that the at least one failure is occurred, at block 720, the terminal device 120 may perform a cell selection in a reestablishment procedure. If determining, at block 730, that one of the at least one second network device 130 with the second indication indicating a combination of the CHO and DAPS is selected, at block 740, the terminal device 120 may release the first connection with the first network device 110 and then establish a second connection between the selected device and the terminal device 120.

For example, if a radio link failure (RLF) happens for the first network device 110, the terminal device 120 may perform cell selection in reestablishment procedure. If the selected cell is a both CHO and DAPS candidate cell, the terminal device 120 should fallback to CHO, i.e. the terminal device 120 only attempts CHO execution without DAPS.

As another example, in case of legacy handover failure or failure to access a CHO candidate cell, the terminal device 120 may perform cell selection in reestablishment procedure. If the selected cell is a both CHO and DAPS candidate cell, the terminal device 120 should fallback to CHO, i.e. the terminal device 120 only attempts CHO execution without DAPS.

FIG. 8 illustrates another example method 800 of failure handling implemented at the terminal device in accordance with some embodiments of the present disclosure. For example, the method 800 may be performed at the terminal device 120 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

As shown in FIG. 8, at block 810, the terminal device 120 may determine whether a failure is occurred in establishment of a second connection between the terminal device 120 and a first device 130 during a DAPS or during a combination of a CHO and DAPS. If determining that the failure is occurred, at block 820, the terminal device 120 may determine whether a failure in a first connection with the first network device 110 is detected.

If determining, at block 820, that the failure in the first connection is detected, at block 830, the terminal device 120 may determine whether one of the at least one second network device 130 with the second indication indicating a combination of a CHO and DAPS is selected.

If determining that one of the at least one second network device 130 with the second indication indicating a combination of a CHO and DAPS is selected, at block 840, the terminal device 120 may release the first connection with the first network device 120, and then establish a second connection between the selected device and the terminal device 120. In other words, if a radio link failure has been detected for the first network device 110, the terminal device 120 may perform a cell selection in reestablishment procedure. If the selected cell is a both CHO and DAPS candidate cell, the terminal device 120 shall fallback to a CHO.

If determining, at block 820, that the failure in the first connection with the first network device 110 is not detected, at block 860, the terminal device 120 may determine whether the first connection is released. If determining that the first connection is not released, the terminal device 120 may perform data transmission using the first connection and ignore the execution of the handover. In other words, if the radio link of the first network device 110 is still under good condition and the first network device 110 is not released, the terminal device 120 shall fallback to the first network device 110. For example, the terminal device may resume the stored RRC context of the first network device 110, and may also continue to evaluate other CHO and both CHO and DAPS candidate cell.

In some embodiments, the terminal device 120 may store the CHO and DAPS failure information in a report of RLF with failure type “CHO+DAPS” failure, and report the CHO and DAPS failure information to the first network device 110, for example, by using RRCReconfigurationComplete message, UEAssistanceInfomation message or other suitable message.

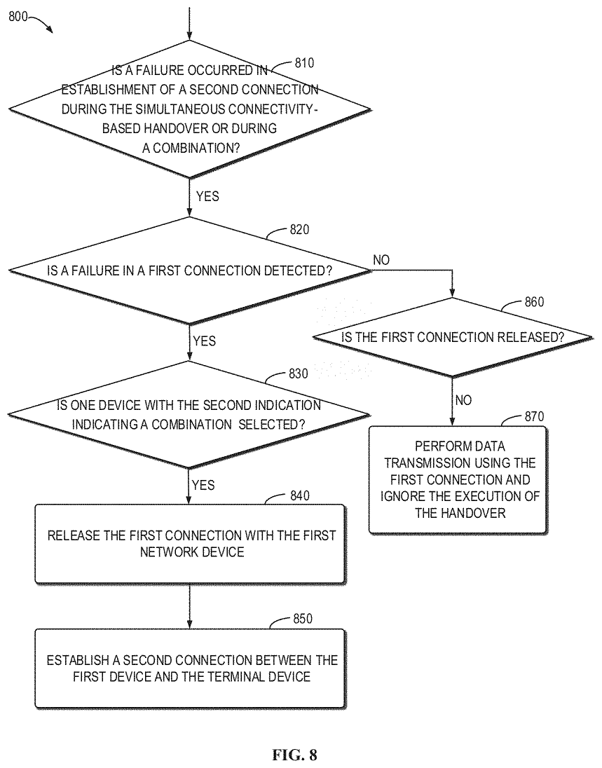

FIG. 9 illustrates an example method 900 of communication implemented at a second network device as a (candidate) target network device in accordance with some embodiments of the present disclosure. For example, the method 900 may be performed at the second network device 130 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

At block 910, the second network device 130 may receive a handover request comprising a first indication regarding a type of a handover to the second network device 130. The type indicates at least one of a CHO and DAPS.

At block 920, the second network device 130 may generate a second indication regarding the type of the handover based on the first indication. In some embodiments, the second indication may be different from the first indication. In some embodiments, the second indication may be the same as the first indication.

At block 930, the second network device 130 may transmit, to the first network device 110, the second indication in an acknowledgement of the handover request, for transmission of a handover command comprising the second indication to a terminal device 120 for execution of the handover.

In some embodiments in which the second indication indicates a combination of a CHO and DAPS, the second network device 130 may further transmit, in the acknowledgement, a first configuration of the second network device 130 that is to be used for the combination. In some embodiments in which capability coordination between the first network device and this second network device is not performed for a DAPS or a combination of a CHO and DAPS, the second network device 130 may generate the first configuration with secondary cells deactivated explicitly.

In some additional embodiments, the second network device 130 may further transmit, in the acknowledgement, a second configuration of the at least one second network device 130 to be used in a fallback process.

In some embodiments, the second network device 130 may further receive, from the first network device 110, downlink data that is to be transmitted to the terminal device 120 and sequence number information associated with the first data packet of the downlink data.

In some embodiments in which a second connection between the second network device 130 and the terminal device 120 is established, the second network device 130 may transmit, to the first network device 110, third information indicating completion of the handover, and receive, from the first network device 110, uplink data that has been received by the first network device 110 from the terminal device 120 and sequence number information associated with the first data packet of the uplink data.

In some embodiments in which the second network device 120 decides to release the first network device 110, switch sequence number allocation anchor to itself, or perform path switch to itself, the second network device 120 may transmit, to the first network device 110, fourth information indicating at least one of the release of the first network device 110, the switch of sequence number allocation, and the path switch from the first network device 110 to the second network device 130, and receive, from the first network device 110, downlink data that is to be transmitted to the terminal device 120 and sequence number information associated with the first data packet of the downlink data.

The implementations of the method described in FIGS. 4-9 substantially correspond to the processes described in connection with FIG. 2, and thus other details are not repeated here. With the methods 400-900 according to embodiments of the present disclosure, a CHO with simultaneous connectivity is achieved, and both a reduction of handover interruption and an improvement of handover robustness are attained.

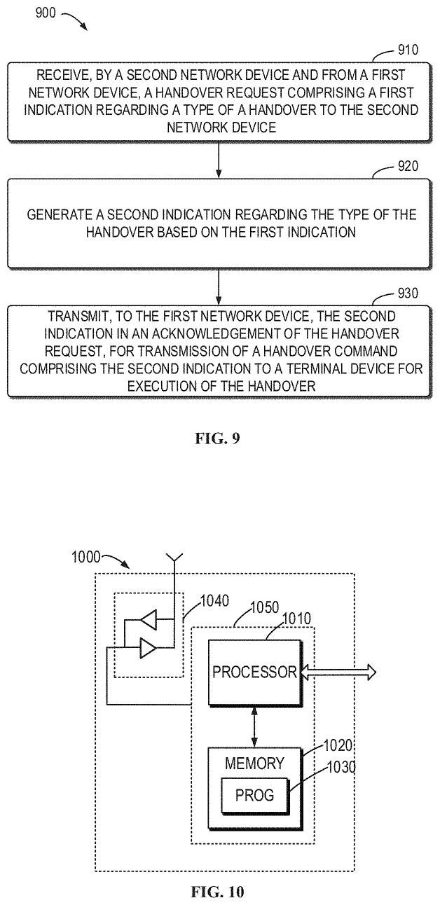

FIG. 10 is a simplified block diagram of a device 1000 that is suitable for implementing embodiments of the present disclosure. The device 1000 can be considered as a further example implementation of the first network device 110, the terminal device 120, or the second network device 130 as shown in FIG. 1. Accordingly, the device 1000 can be implemented at or as at least a part of the first network device 110, the terminal device 120, or the second network device 130.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones.

The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 1 to 9.

The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 4 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-46. (canceled)

47. A method of communication, comprising:
transmitting, by a first network device and to each of at least one second network device, a handover request comprising a first indication regarding a type of a handover to the second network device, the type indicating at least one of a condition-based handover and a simultaneous connectivity-based handover;
receiving, from each of the at least one second network device, an acknowledgement of the handover request, the acknowledgement comprising a second indication regarding the type of the handover; and
transmitting, to a terminal device, a handover command comprising the second indication, for execution of the handover to a first device of the at least one second network device.

48. The method of claim 47, wherein the second indication indicates a combination of the condition-based handover and the simultaneous connectivity-based handover, and
wherein the acknowledgement further comprises a first configuration of the second network device that is to be used for the combination.

49. The method of claim 48, wherein the acknowledgement further comprises a second configuration of the second network device that is to be used in a fallback process.

50. The method of claim 47, further comprising: transmitting configuration information associated with the handover to the terminal device, the configuration information being provided for each of the at least one second network device and comprising at least one of the following:
an identification of the second network device;
a condition of an execution of the handover;
a third indication regarding whether capability coordination between the first network device and the second network device has been performed;
a first configuration regarding the second network device that is to be used for a combination of the condition-based handover and the simultaneous connectivity-based handover;
a second configuration regarding the second network device that is to be used in a fallback process; and
a third configuration regarding the first network device that is to be used during the handover.

51. The method of claim 47, wherein the at least one second network device comprises a single second network device, and the method further comprises:
in response to transmitting the handover command, transmitting, to the single second network device, downlink data that is to be transmitted to the terminal device and sequence number information associated with the first data packet of the downlink data.

52. The method of claim 47, further comprising:
receiving a fourth indication regarding establishment of a second connection between the first device and the terminal device having a first connection with the first network device; and
in response to receiving the fourth indication, transmitting, to the first device, downlink data that is to be transmitted to the terminal device and sequence number information associated with the first data packet of the downlink data.

53. The method of claim 47, further comprising:
receiving, from the first device, third information indicating completion of a handover to the first device; and
in response to receiving the third information and deciding to stop scheduling uplink data to the terminal device, transmitting, to the first device, uplink data that has been received by the first network device from the terminal device and sequence number information associated with the first data packet of the uplink data.

54. The method of claim 47, further comprising:
receiving, from the first device, third information indicating completion of the handover to the first device;
receiving, from the first device, fourth information indicating at least one of a release of the first network device, a switch of sequence number allocation, and path switch from the first network device to the first device; and
in response to receiving the third and fourth information, transmitting, to the first device, downlink data that is to be transmitted to the terminal device and sequence number information associated with the first data packet of the downlink data.

55. A method of communication, comprising:
receiving, at a terminal device and from a first network device, a handover command comprising a second indication regarding a type of a handover to each of at least one second network device, the type indicating at least one of a condition-based handover and a simultaneous connectivity-based handover; and
executing the handover to a first device of the at least one second network device based on the second indication.

56. The method of claim 55, further comprising: receiving, from the first network device, configuration information associated with the handover, the configuration information being provided for each of the at least one second network device and comprising at least one of the following:
an identification of the second network device;
a condition of an execution of the handover;
a third indication regarding whether capability coordination between the first network device and the second network device has been performed;
a first configuration regarding the second network device that is to be used for a combination of the condition-based handover and the simultaneous connectivity-based handover;
a second configuration regarding the second network device that is to be used in a fallback process; and
a third configuration regarding the first network device that is to be used during the handover.

57. The method of claim 55, wherein the second indication indicates a combination of the condition-based handover and the simultaneous connectivity-based handover,
wherein the configuration information does not comprise a third configuration regarding the first network device that is to be used during the handover, and
wherein executing the handover comprises, in response to a condition of an execution of the handover being satisfied by the first device:
in response to capability coordination between the first network device and the first device having been performed, establishing, using a first configuration regarding the first device that is to be used for the combination, a second connection between the first device and the terminal device having a first connection with the first network device in a current configuration; and
in response to the capability coordination having not been performed, and a combination of the current configuration with secondary cells deactivated and the first configuration with secondary cells deactivated being below capabilities of the terminal device, establishing, using the first configuration with secondary cells deactivated, the second connection between the first device and the terminal device having the first connection with the first network device in the current configuration with secondary cells deactivated.

58. The method of claim 57, further comprising:
transmitting, to the first network device, a fourth indication regarding the establishment of the second connection.

59. The method of claim 57, further comprising: in response to the capability coordination having not been performed and the combination being above the capabilities of the terminal device, performing a fallback process.

60. The method of claim 59, wherein the fallback process comprises at least one of the following:
upon releasing the first connection with the first network device, establishing the second connection between the first device and the terminal device;
maintaining the first connection with the first network device in the current configuration until initiating a random access to the first device in establishment of the second connection between the first device and the terminal device; and
ignoring the execution of the handover.

61. The method of claim 55, wherein the second indication indicates a combination of the condition-based handover and the simultaneous connectivity-based handover,
wherein the configuration information comprises a third configuration regarding the first network device that is to be used during the handover, and
wherein executing the handover comprises, in response to a condition of an execution of the handover being satisfied by the first device:
in response to capability coordination between the first network device and the first device having been performed,
establishing, using a first configuration regarding the first device that is to be used for the combination, a second connection between the first device and the terminal device having a first connection with the first network device in the third configuration, and
transmitting, to the first network device, a fourth indication regarding the establishment of the second connection; and
in response to the capability coordination having not been performed, and a combination of the third configuration with secondary cells deactivated and the first configuration with secondary cells deactivated being below capabilities of the terminal device,
transmitting, using the current configuration and to the first network device, the fourth indication regarding the establishment of the second connection,
in response to the fourth indication being successfully transmitted, establishing, using the first configuration with secondary cells deactivated, the second connection between the first device and the terminal device having the first connection with the first network device in the third configuration with secondary cells deactivated, and
in response to the fourth indication being not successfully transmitted, performing a fallback process.

62. The method of claim 61, wherein the fallback process comprises at least one of the following:
upon releasing the first connection with the first network device, establishing the second connection between the first device and the terminal device;
maintaining the first connection with the first network device in the current configuration until initiating a random access to the first device in establishment of the second connection between the first device and the terminal device; and
ignoring the execution of the handover.

63. The method of claim 55, further comprising:
in response to at least one of the following being occurred: a failure in a first connection between the terminal device and the first network device, a failure in establishment of a second connection between the terminal device and the first device during the condition-based handover, or a failure in establishment of a third connection between the terminal device and a third network device during a handover other than the condition-based handover and the simultaneous connectivity-based handover,
performing a cell selection in a reestablishment procedure; and
in response to selecting one of the at least one second network device with the second indication indicating a combination of the condition-based handover and the simultaneous connectivity-based handover,
releasing the first connection with the first network device, and
establishing a second connection between the selected device and the terminal device.

64. The method of claim 55, further comprising:
in response to a failure being occurred in establishment of a second connection between the terminal device and a first device during the simultaneous connectivity-based handover or during a combination of the condition-based handover and the simultaneous connectivity-based handover,
in response to a failure in a first connection with the first network device being detected, and one of the at least one second network device with the second indication indicating a combination of the condition-based handover and the simultaneous connectivity-based handover being selected,
releasing the first connection with the first network device, and
establishing a second connection between the selected device and the terminal device; and
in response to the failure in the first connection with the first network device being not detected and the first connection being not released, performing data transmission using the first connection and ignoring the execution of the handover.

65. A first network device comprising:
a processor configured to perform the method according to claim 47.

66. A terminal device comprising:
a processor configured to perform the method according to claim 55.
